(19) United States
(12) Patent Application Publication
(10) Pub. No.: US 2020/0230762 A1
(43) Pub. Date: Jul. 23, 2020

(54) AUTOMATIC TOOL LOADING FOR MILLING MACHINE

(71) Applicant: The Boeing Company, Chicago, IL (US)

(72) Inventor: Jeffrey H Olberg, Federal Way, WA (US)

(21) Appl. No.: 16/255,549

(22) Filed: Jan. 23, 2019

(51) Int. Cl. B23Q 3/157; B23B 31/26

(52) U.S. Cl. CPC B23Q 3/15773; B23B 31/26

(57) ABSTRACT

Systems and methods are provided for automatic tool loading of a milling machine. One embodiment is an apparatus for loading tools into a milling machine. The apparatus includes a base platform configured to rest on a table of the milling machine, and a support column extending vertically from the base platform. The apparatus also includes a holding member slidably coupled with the support column above the base platform, the holding member extending horizontally from the support column and configured to translate vertically along the support column, and to support a tool holder in an upright position for loading the tool holder into a spindle of the milling machine.

### FIELD

The disclosure relates to the field of milling machines, and in particular, to tool loading of milling machines.

### BACKGROUND

Modern machining shops, such as those used in aircraft manufacturing, often employ a computer numerically controlled (CNC) milling machine to create and finish parts with high precision. These milling machines often include a tool magazine with a variety of cutting tools that can be easily swapped into the spindle for milling. The cutting tools are held in respective tool holders that provide a physical interface between the cutting tools and the spindle of the milling machine. The tool holders have a common standardized body shape for swapping the cutting tools in the spindle. Unfortunately, it can be difficult for an operator to load a new tool holder and tool into the milling machine due to the location of the spindle and the weight of the tool holder.

### SUMMARY

Embodiments described herein provide automatic tool loading for a milling machine. A tool loading device is placed on the table of the milling machine to assist an operator in loading new tools into a milling machine. The tool loading device suspends a tool holder above the table in an upright position. The tool holder holds a milling tool for cutting a workpiece. A pneumatic actuator, spring, or the like supports the weight of the tool holder and its cutting tool. The milling machine is controlled to position the tool loading device underneath the spindle of the milling machine. With the spindle positioned over the tool loading device, the spindle moves down to accept the tool holder and load the tool holder and its cutting tool into the milling machine. The tool loading device advantageously enables the milling machine to automatically load a new tool holder into the spindle without requiring an operator to reach with the holding tool in their hand to extend the holding tool into the milling machine and up into the spindle.

One embodiment is an apparatus for loading tools into a milling machine. The apparatus includes a base platform configured to rest on a table of the milling machine, and a support column extending vertically from the base platform. The apparatus also includes a holding member slidably coupled with the support column above the base platform, the holding member extending horizontally from the support column and configured to translate vertically along the support column, and to support a tool holder in an upright position for loading the tool holder into a spindle of the milling machine.

Another embodiment is a of loading a tool into a milling machine. The method includes receiving, at a controller of the milling machine, reference position information of a tool loading device positioned with respect to a table of the milling machine, the tool loading device including a base platform to attach to the table, a support column extending vertically from the base platform, and a holding member to slide along the support column. The method also includes supporting a tool holder including the tool on the holding member to suspend the tool holder along the support column, and sliding the table and the tool loading device attached thereto based on the reference position information to position the tool holder directly underneath a spindle of the milling machine. The further includes moving the spindle downwardly over the tool holder, and directing the spindle to receive the tool holder.

Yet another embodiment is a system that includes a milling machine. The milling machine includes a spindle configured to rotate a cutting tool, a table configured to support a workpiece for cutting with the cutting tool, and a controller configured to position the table and the spindle with respect to one another. The system also includes a tool loading device for loading tool holders and respective cutting tools into the milling machine. The tool loading device includes a base platform configured to rest on the table of the milling machine, a support column extending vertically from the base platform, and a holding member mechanically coupled with the support column above the base platform, the holding member extending horizontally from the support column and configured to support a tool holder in an upright position for loading the tool holder into the spindle of the milling machine.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a front view of a milling machine.

FIG. 2 illustrates a tool holder.

FIG. 3 illustrates a tool loading device in an illustrative embodiment.

FIG. 4A is a top perspective view of a holding member of a tool loading device in an illustrative embodiment.

FIG. 4B is a front perspective view of a tool loading device in another illustrative embodiment.

FIG. 5 is a block diagram of a milling machine in an illustrative embodiment.

FIG. 6 is a flowchart illustrating a method for automatically loading a tool holder into a milling machine in an illustrative embodiment.

### DESCRIPTION

The figures and the following description illustrate specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

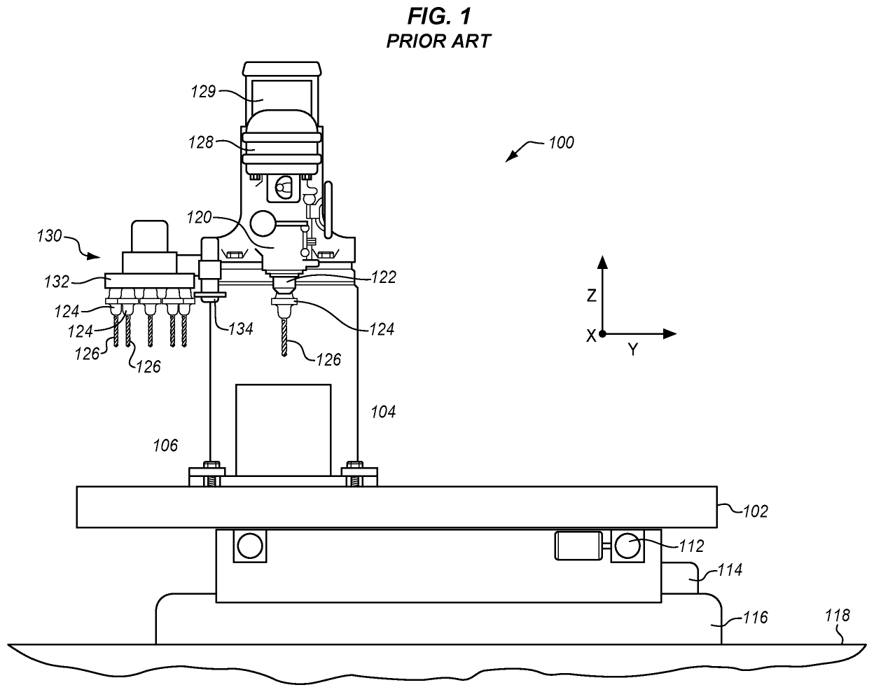

FIG. 1 is a front view of a milling machine 100. The milling machine 100 includes a table 102 that supports a workpiece 104. Generally, the workpiece 104 is secured to the table 102 via a vise 106, and the table 102 and the workpiece 104 slide together laterally via an x-axis slide 112 (e.g., to move forward/rearward along the x-direction) and/or y-axis slide 114 (e.g., to move left/right along the y-direction). The slides 112-114 and the table 102 are supported by a base 116 which rests on a floor 118 of the machining shop.

The milling machine 100 further includes a spindle 120 having a socket 122 that grips and rotates a tool holder 124 which in turn grips and rotates a cutting tool 126. The spindle 120, the tool holder 124, and the cutting tool 126 may move vertically via a z-axis slide 129 (e.g., to move up/down along z-axis). Additionally, the spindle 120, the tool holder 124, and the cutting tool 126 rotate under the power of a spindle drive motor 128 for milling, drilling, boring, or reaming the workpiece 104 with the cutting tool 126. During operation, the table 102 and/or the spindle 120 are moved with respect to one another according to predefined programming or operator input to shape and finish the workpiece 104 with the cutting tool 126 as desired. That is, the spindle drive motor 128 and motors controlling movement in the x, y, and z directions may be controlled by a special-purpose computer programmed to execute computer numerical control (CNC).

The milling machine 100 may further include an automatic tool changer 130 to automatically swap tools in the spindle 120. For instance, the automatic tool changer 130 may include a tool magazine 132 that stores a plurality of tool holders 124 and respective cutting tools 126. The automatic tool changer 130 may include a swing arm 134 to change a tool holder 124 and the cutting tool 126 that it holds between the tool magazine 132 and the spindle 120. Alternatively or additionally, the automatic tool changer 130 may comprise a carousel-type tool change mechanism. Numerous variations in features and configurations of the milling machine 100 are possible.

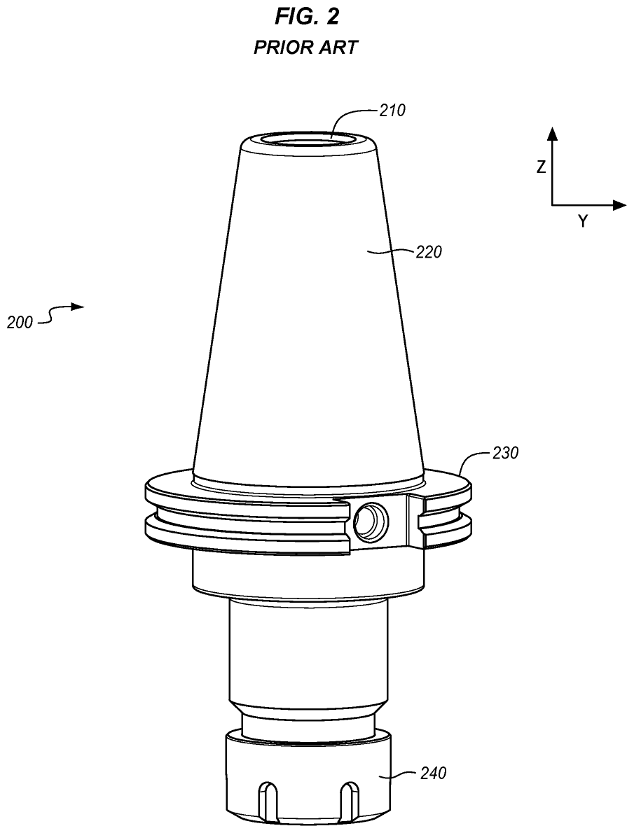

FIG. 2 illustrates a tool holder 200. In general, the tool holder 200 enables a milling machine to be compatible with a wide variety of cutting tools. That is, the tool holder 200 provides a standardized physical interface between a milling machine and a cutting tool. In this example, the tool holder 200 includes a machine interface 210, a tapered shank 220, a V-flange 230, and a tool interface 240. The machine interface 210 may receive a retention knob (not shown) that holds the tool holder 200 in the spindle of the milling machine during machining operations. The tapered shank 220 includes a conically-shaped area of the tool holder 200 that enters into the spindle of the milling machine. The V-flange 230 is the part of the tool holder 200 gripped by the automatic tool changer when the tool holder 200 is moved from the tool changer to the spindle. The tool interface 240 includes the collet pocket into which a collet is inserted and secured by a collet nut. The collet holds the cutting tool for milling the workpiece.

Previously, to load the tool holder 200 into a milling machine, the operator holds the tool holder 200 with one hand to press the tool holder 200 upward into the spindle, while using the other hand to operate a switch to lock/unlock the tool holder 200 in the spindle. Due to the size of many modern milling machines, the operator must reach with their arm, shoulder, and back to extend the tool holder 200 across the milling table (e.g., table 102) and up into the spindle. The height of the spindle from the floor 118 of the machining shop can be as tall or taller than the operator. Additionally, the tool holder 200 can sometimes weigh as much as thirty pounds. Therefore, it is difficult for the operator to repetitively load new cutting tools and tool holders into the milling machine.

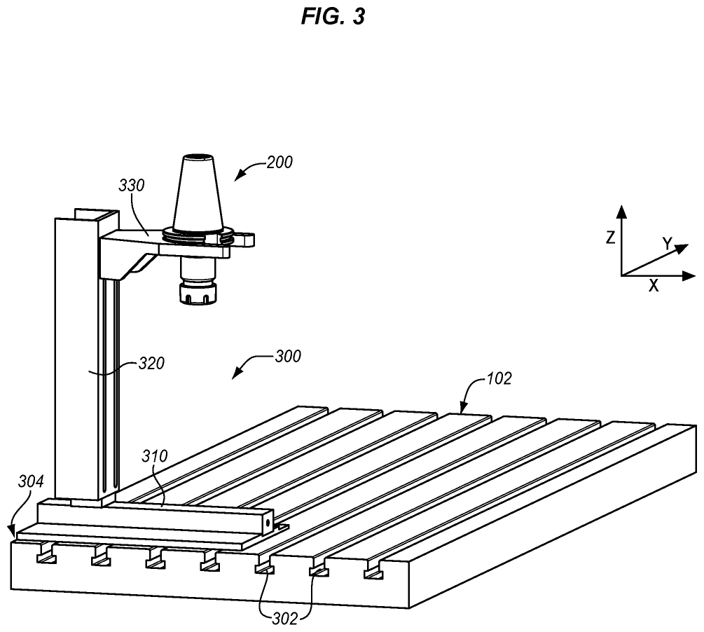

FIG. 3 illustrates a tool loading device 300 in an illustrative embodiment. In general, the tool loading device 300 supports a tool holder (e.g., tool holder 200) in an upright position for semi-automatic tool loading into the spindle of a milling machine. The tool loading device 300 eliminates operator reach/extension the tool holder 200 into the milling machine, thereby improving the process of loading new tools into a milling machine and also improving worker and worksite safety. Although the tool loading device 300 and further embodiments thereof are described with respect to the tool holder 200 of FIG. 2, it will be appreciated that features thereof may apply to numerous different types of tool holders. Examples of different types of tool holders include CAT® tool holders, Hollow Shank Tooling (HSK) tool holders, and National Machine Tool Builders (NMTB) tool holders. Similarly, while the tool loading device 300 and further embodiments thereof are described with respect to the milling machine 100 of FIG. 1, it will be appreciated that features thereof may apply to numerous variations and types of milling machines.

The tool loading device 300 includes a base platform 310 that rests on the table 102 of the milling machine 100. The base platform 310 may be loaded onto the table 102 using a datum 304 that defines a location of the tool loading device 300 with respect to the table 102 of the milling machine 100. As described in greater detail below, the datum 304 ensures that the automatic loading of tool holders is accurate and repeatable. In some embodiments, the base platform 310 is configured to couple with slots 302 (e.g., T-slots) in the table 102 of the milling machine 100 to secure the tool loading device 300 with the table 102.

The tool loading device 300 also includes a support column 320 extending vertically from the base platform 310, and a holding member 330 mechanically coupled with the support column 320 above the base platform 310. The holding member 330 extends horizontally from the support column 320 and is configured to support the tool holder 200 in an upright position for loading the tool holder 200 into the spindle 120 of the milling machine 100. Thus, the tool loading device 300 provides a technical benefit in enabling the milling machine 100 to maneuver the table 102 to position the tool holder 200 directly underneath the spindle 120 to automatically load the tool holder 200, and the cutting tool it holds, into the spindle 120 without an operator supporting the tool holder 200 with one hand and/or or reaching it into the milling machine 100.

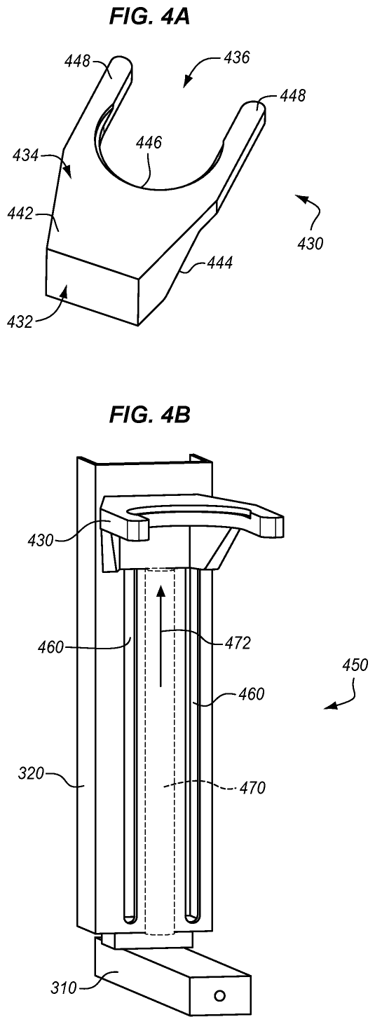

FIG. 4A is a top perspective view of a holding member 430 of a tool loading device in an illustrative embodiment. The holding member 430 includes a base end 432 to couple with the support column 320, a platform 434 extending horizontally from the base end 432, and a front end 436 distal from the base end 432 to receive the tool holder 200. The platform 434 includes a top side 442 having a flat horizontal surface and a bottom side 444 that structurally supports the horizontal extension of the platform 434 from the base end 432.

Additionally, the front end 436 includes an indention 446 in the platform 434 that is sized to support the tool holder 200. The indention 446 may include a circular or semi-circular indentation or gap between fork members 448 that support underneath the flange (e.g., V-flange 230) of the tool holder 200. That is, the indention 446 and/or gap between the fork members 448 may be sized to correspond with the flange so that the bottom of the flange rests flatly on the top side 442 of the platform 434. The holding member 430 thus suspends the tool holder 200 vertically above the base platform 310 and the table 102 with the machine interface 210 and the tapered shank 220 of the tool holder 200 oriented upright toward the spindle 120.

FIG. 4B is a front perspective view of a tool loading device 450 in another illustrative embodiment. In this embodiment, the support column 320 includes vertical slits 460, and the holding member 430 is mechanically coupled with the support column 320 and configured to slide vertically along one or more vertical slits 460 extending lengthwise along the support column 320. Additionally, the tool loading device 450 includes a stabilizer member 470 disposed along the support column 320 and configured to apply an upward force 472 (e.g., in the z-direction) to the holding member 430. In one embodiment, the stabilizer member 470 includes a pneumatic actuator. Alternatively or additionally, the stabilizer member 470 may include a spring.

The upward force 472 of the stabilizer member 470 opposes a weight of the tool holder 200 held in the holding member 430. The stabilizer member 470 may therefore be configured to supply the upward force 472 to correspond with a weight or range of weights of tool holders to be loaded into a milling machine. For example, the upward force 472 may apply a force to support tool holders weighing between seven and thirty pounds. The stabilizer member 470 thus suspends the holding member 430 and its tool holder 200 at a vertical position along the vertical slits 460 according to the upward force 472 and weight of the holding member 430, tool holder 200, and cutting tool held in the tool holder 200.

The stabilizer member 470 and the vertical slits 460 may be oriented lengthwise and parallel with one another and with the support column 320. Additionally, the stabilizer member 470 may be disposed inside or adjacent to the support column 320, with a bottom end extending toward the base platform 310 and a top end supporting the bottom side 444 of the holding member 430. The base end 432 of the holding member 430 may slidably couple with the vertical slits 460 to suspend the tool holder 200 with a springing/sliding motion via the stabilizer member 470. Alternatively or additionally, the holding member 430 may slidably couple with the support column 320 via rails or the body of the support column 320. Thus, the holding member 430 is configured to fully support the weight of the tool holder 200 in an upright position and with vertical maneuverability or play via the upward force 472 of the stabilizer member 470.

The tool loading device 450 provides a technical benefit in enabling further automation in loading the tool holder 200 into the spindle 120 of the milling machine 100. That is, with the upward force 472 of the stabilizer member 470 applied to the holding member 430, the tool holder 200 is suspended by the tool loading device 450 with a springing force. This allows the spindle 120 to move down onto the tool holder 200 and to press the tool holder 200 downward some vertical distance against the springing force. The milling machine 100 may then be controlled to activate its tool release, allowing the retention stud on the end of the tool holder 200 (e.g., threaded into the machine interface 210) to rise up into the spindle 120 into a fully seated position under the springing force. Thus, an operator need not hold/press the tool holder 200 up into the spindle 120 while manually operating the switch to lock/unlock the spindle 120.

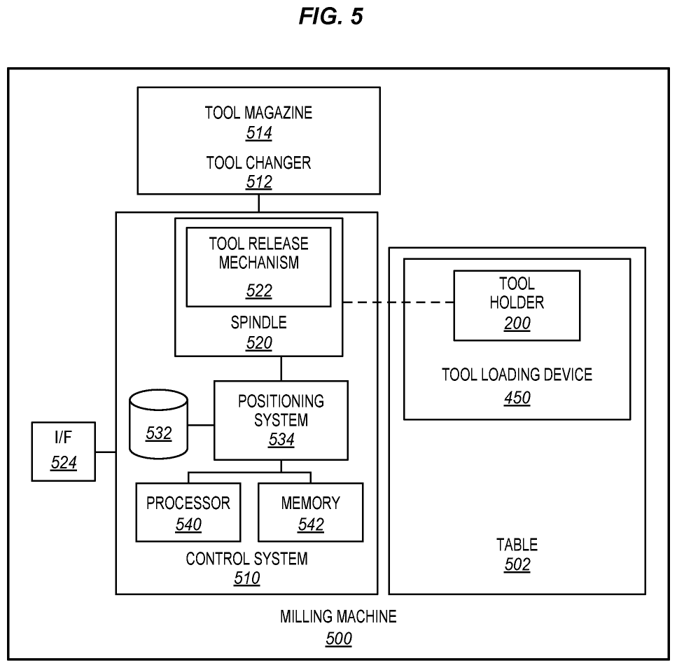

FIG. 5 is a block diagram of a milling machine 500 in an illustrative embodiment. The milling machine 500 includes a table 502, a control system 510, and a tool changer 512. The tool changer 512 includes a tool magazine 514 configured to store a plurality of tool holders and respective cutting tools. The tool changer 512 is configured to swap tools between the tool magazine 514 and a spindle 520 of the milling machine 500. The spindle 520 includes a tool release mechanism 522, or clamp, that opens/closes to unlock/lock the retention stud on the end of a tool holder. The tool release mechanism 522 may be activated automatically by a control system 510 of the milling machine 500. Alternativley or additionally, the tool release mechanism 522 may be activated by operator input to an interface 524 or a mechanical switch of the milling machine 500. The interface 524 is any device or combination of devices to receive user input at the milling machine 500. For example, the interface 524 may include a Graphical User Interface (GUI) to receive and display data for the milling machine 500.

The milling machine 500 is enhanced with a control system 510 configured to automatically load new tool holders and respective cutting tools using tool loading data 532 received via the interface 524. The control system 510 stores settings of the tool loading data 532 for use by a positioning system 534 to position the table 502 and/or the spindle 520 for loading new tools into the milling machine 500. The positioning system 534 may therefore position the tool loading device 450 placed on the table 502, and thus the tool holder 200 supported by the tool loading device 450, with respect to the spindle 120 using coordinate data and the tool loading data 532. For example, the coordinate data may describe the x, y, z position of the table 502, the tool loading device 450, and/or the tool holder 200 in a Cartesian coordinate system with respect to a reference point (e.g., datum 304). The tool loading data 532 may include a coordinate value of the datum 304, one or more characteristics of the tool loading device 450 (e.g., the value of the upward force 472 of the stabilizer member 470, dimensions of components, etc.), a weight, size, or type of the tool holder 200 to be held by the tool loading device 450 for loading into the spindle 520, and/or a weight, size, or type of the cutting tool held in the tool holder 200. Accordingly, the positioning system 534 is configured to track/determine the spatial coordinate position of the tool holder 200 as a function of the coordinate system and the reference point of the tool loading device 450.

The control system 510 may comprise hardware, software, or a combination of hardware and software. For example, the control system 510 may include a processor 540, which includes any electronic circuits and/or optical circuits that are able to perform functions. The processor 540 may include one or more Central Processing Units (CPU), microprocessors, Digital Signal Processors (DSPs), Application-Specific Integrated Circuits (ASICs), Programmable Logic Devices (PLD), control circuitry, etc. Some examples of processors include Intel® Core™ processors, Advanced Reduced Instruction Set Computing (RISC) Machines (ARM®) processors, etc. The control system 510 may also include memory 542, which may include any electronic circuits, optical circuits, and/or magnetic circuits that are able to store data. Additionally, the control system 510 may include one or more linear drive mechanisms, one or more linear guides, one or more linear measuring instruments to position the table 502 in the x-y plane and to position the spindle 520 at a vertical position in the z-axis.

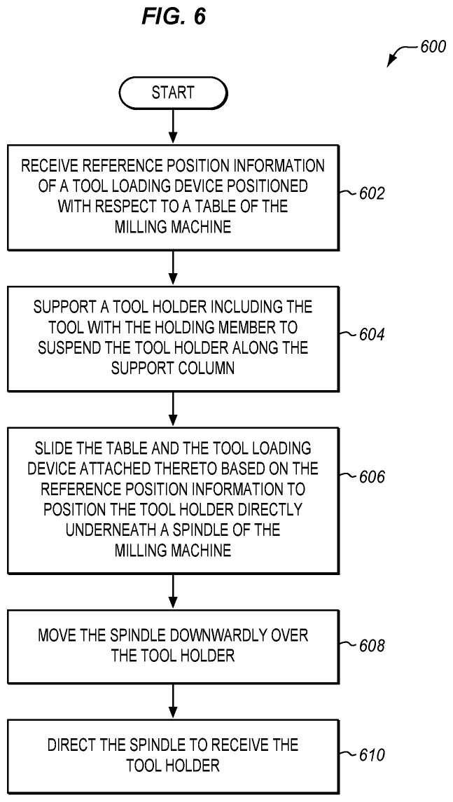

FIG. 6 is a flowchart illustrating a method 600 for automatically loading a tool holder into a milling machine in an illustrative embodiment. The steps of the flowchart(s) will be described with reference to FIGS. 1-5, but those skilled in the art will appreciate that the methods may be performed in other systems and devices. The steps of the flowchart(s) described herein are not all inclusive, may include other steps not shown, and may be performed in an alternative order. Assume, for this embodiment, that the tool loading device 450 is placed on the table 502 of the milling machine 500 using the datum 304. Further assume that the appropriate tool holder 200 and respectively held cutting tool is selected for loading into the milling machine 500.

In step 602, the control system 510 of the milling machine 500 receives reference position information of the tool loading device 450 positioned with respect to the table 502 of the milling machine 500. For example, the control system 510 may receive input indicating a coordinate position of the datum 304 describing the position/orientation of the tool loading device 450 on the table 502. Alternatively or additionally, the control system 510 may receive input indicating one or more types of the tool loading data 532 described above.

In step 604, the holding member 430 supports the tool holder 200 and the cutting tool with the holding member 430 to suspend the tool holder 200 along the support column 320. The holding member 430 may suspend the tool holder 200 via an actuator (e.g., stabilizer member 470) applying an upward force to oppose a weight of the tool holder 200. The control system 510 may calculate a lateral position and/or vertical height of the tool holder 200 using the information obtained in step 602. The calculated positions may be transmitted to the positioning system 534 for automatically controlling the movement of the table 502 and/or the spindle 520.

In step 606, the positioning system 534 slides the table 502 and the tool loading device 450 attached thereto based on the reference position information to position the tool holder 200 directly underneath the spindle 520. For example, the table 502 may slide to a home position (e.g., in the forward x-direction or toward the operator) for attaching the tool loading device 450 on the table 502 with respect to the datum 304. The positioning system 534 may then move the table 502 to a tool loading position where a centerline of the holding member 430 aligns vertically with the spindle 520. Assuming the location of the datum 304 and the tool loading device 450 with respect to the table 502 remain the same, the control system 510 may move the table 502 in the x-y plane to the tool loading position each time a tool loading operation is initiated.

In step 608, the positioning system 534 moves the spindle 520 downwardly over the tool holder 200. In some embodiments, the spindle 520 is controlled based on calculated position information to contact the tool holder 200 and press the tool holder 200 downward for a distance. For example, the downward movement of the spindle 520 may be based on a weight of the tool holder 200 and its cutting tool or a vertical height of the tool holder 200 due to its weight against the vertical force of the actuator. The downward movement of the tool holder 200 imparts a corresponding downward movement of the hold member 430 along the vertical slits 460. Additionally, the downward contact/movement opposes the upward force of the actuator.

In step 610, the control system 510 directs the spindle 520 to receive the tool holder 200. That is, the control system 510 may direct the spindle 520 to receive the tool holder includes activating a clamp (e.g., tool release mechanism 522) of the spindle 520 to open to allow the tool holder 200 to rise via the upward force of the actuator into a seated position with the spindle 520, and activating the clamp to close to load the tool holder 200 into the spindle 520. Thus, after positioning the spindle 520 to a programmed or calculated height, the control system 510 may command the milling machine 500 to activate the tool release mechanism 522 allowing the retention stud on the end of the tool holder 200 to rise up to full seat position.

With the tool holder 200 loaded into the spindle 520, the milling machine 500 may store the tool holder 200 and its cutting tool in the tool magazine 514 and recall the cutting tool for use in the spindle 520 as desired. The tool loading device 450 may be removed/detached from the table 502 to clear the way for operating the spindle 520 to mill a workpiece.

Any of the various control elements (e.g., electrical or electronic components) shown in the figures or described herein may be implemented as hardware, a processor implementing software, a processor implementing firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, a control element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments are described herein, the scope of the disclosure is not limited to those specific embodiments. The scope of the disclosure is defined by the following claims and any equivalents thereof.

1. An apparatus for loading tools into a milling machine, the apparatus comprising:
a base platform configured to rest on a table of the milling machine;
a support column extending vertically from the base platform; and
a holding member slidably coupled with the support column above the base platform, the holding member extending horizontally from the support column and configured to translate vertically along the support column, and to support a tool holder in an upright position for loading the tool holder into a spindle of the milling machine.

2. The apparatus of claim 1 further comprising:
a pneumatic actuator configured to apply an upward force to the holding member.

3. The apparatus of claim 2 wherein:
a weight of the tool holder in the holding member opposes the upward force of the pneumatic actuator.

4. The apparatus of claim 1 further comprising:
a spring configured to apply an upward force to the holding member.

5. The apparatus of claim 1 wherein:
the holding member includes a platform with a circular indentation to support a flange of the tool holder.

6. The apparatus of claim 1 wherein:
the base platform is configured to couple with slots in the table of the milling machine to secure the apparatus with the table.

7. The apparatus of claim 1 wherein:
the base platform positions with respect to the table via a datum.

8. A method of loading a tool into a milling machine, the method comprising:
receiving, at a controller of the milling machine, reference position information of a tool loading device positioned with respect to a table of the milling machine, the tool loading device including a base platform to attach to the table, a support column extending vertically from the base platform, and a holding member to slide along the support column;
supporting a tool holder including the tool on the holding member to suspend the tool holder along the support column;
sliding the table and the tool loading device attached thereto based on the reference position information to position the tool holder directly underneath a spindle of the milling machine;
moving the spindle downwardly over the tool holder; and
directing the spindle to receive the tool holder.

9. The method of claim 8 wherein:
moving the spindle downwardly includes contacting the tool holder to press the tool holder downwardly for a distance against an upward force of an actuator.

10. The method of claim 9 wherein:
directing the spindle to receive the tool holder includes activating a clamp of the spindle to open to allow the tool holder to rise via the upward force of the actuator into a seated position with the spindle, and activating the clamp to close to load the tool holder into the spindle.

11. The method of claim 9 further comprising:
receiving, at the controller of the milling machine, weight information of the tool holder; and
directing the spindle to move downwardly based on the weight information of the tool holder.

12. The method of claim 8 further comprising:
positioning the tool loading device on the table with a datum; and
directing the table to align the holding member underneath the spindle based on the datum.

13. The method of claim 8 further comprising:
storing the tool holder including the tool in a tool magazine of the milling machine.

14. A system comprising:
a milling machine comprising:
a spindle configured to rotate a cutting tool;
a table configured to support a workpiece for cutting with the cutting tool; and
a controller configured to position the table and the spindle with respect to one another; and
a tool loading device for loading tool holders and respective cutting tools into the milling machine, the tool loading device comprising:
a base platform configured to rest on the table of the milling machine;
a support column extending vertically from the base platform; and
a holding member mechanically coupled with the support column above the base platform, the holding member extending horizontally from the support column and configured to support a tool holder in an upright position for loading the tool holder into the spindle of the milling machine.

15. The system of claim 14 wherein:
the controller is configured to receive reference position information of the tool loading device, and to move the table based on the reference position information to position the holding member and the tool holder underneath the spindle.

16. The system of claim 14 wherein:
the controller is configured to receive weight information of the tool holder, and to move the spindle downwardly based on the weight information to receive a tapered shank of the tool holder into the spindle.

17. The system of claim 14 wherein:
the tool loading device further includes a pneumatic actuator disposed along the support column and configured to apply an upward force to the holding member.

18. The system of claim 17 wherein:
the holding member is configured to slide vertically along the support column; and
a weight of the tool holder in the holding member opposes the upward force of the pneumatic actuator.

19. The system of claim 14 wherein:
the holding member includes a platform with a circular indentation to support a flange of the tool holder.

20. The system of claim 14 wherein:
the base platform is configured to couple with slots in the table of the milling machine to secure the tool loading device with the table.
